(19) United States
(12) Patent Application Publication
(10) Pub. No.: US 2007/0267459 A1
(43) Pub. Date: Nov. 22, 2007

(54) Nail gun

(76) Inventor: Brad Yang, Tali City (TW)

Correspondence Address: HERSHKOVITZ & ASSOCIATES, 2845 DUKE STREET, ALEXANDRIA, VA, 22314, US

(21) Appl. No.: 11/437,742

(22) Filed: May 22, 2006

(51) Int. Cl. B25C 1/04

(52) U.S. Cl. 227/130

(57) ABSTRACT

A nail gun has a gun body, a muzzle and a spring. The muzzle is pivotally mounted on the gun body. The muzzle has a top case, a bottom case, a first pin and a second pin. The top case and the bottom case both have an engaging part and the top case and the bottom case are connected with each other by the engaging parts. A channel is formed between the top case and the bottom case. The spring is mounted around the second pin and between the muzzle and the gun body. When the nail gun is in use, a nail passes through the channel, and the muzzle is pivoted to open around the pins and the engaging parts, therefore, the nail is applied with a balance force when passing through the channel to make the nail moving along a straight path.

### BACKGROUND OF THE INVENTION

1. Field of the Invention

The present invention relates to a nail gun, and more particularly to a nail gun with a muzzle.

2. Description of Related Art

Pneumatic nail guns are widely used for decoration. Nails stored inside the pneumatic nail gun are driven and shot from the nail gun by compressed air.

A conventional pneumatic nail gun has a gun body and a muzzle. The muzzle is mounted on the gun body and comprises a top, a base, a channel and two elastic collars. The channel is defined between the top and the base. The muzzle has a taper shape. The top and the base are pivotally connected to the gun body with the elastic collars. The top and the base of the muzzle will be pivoted to open when a nail passes through the muzzle. Because the two elastic collars hold the top and the base of the muzzle, the movement of the top and the base held by the elastic collars cannot be expected. Therefore, a nail is applied with an unbalance force when the nail passes through the channel, and the nail will not move along a straight path.

To overcome the shortcomings, the present invention tends to provide a nail gun to mitigate the aforementioned problems.

### SUMMARY OF THE INVENTION

The primary objective of the present invention is to provide a nail gun that is convenient for use.

A nail gun has a gun body, a muzzle and a spring. The muzzle is pivotally mounted on the gun body. The muzzle has a top case, a bottom case, a first pin and a second pin. The top case and the bottom case both have an engaging part and the top case and the bottom case are connected with each other by the engaging parts. A channel is formed between the top case and the bottom case. The spring is mounted between the muzzle and the gun body.

When the nail gun is in use, a nail passes through the channel, and the muzzle is pivoted to open around the pins and the engaging parts, therefore, a balance force is applied to the nail when passing through the channel to make the nail moving along a straight path.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a muzzle of a nail gun in accordance with the present invention;

FIG. 2 is an enlarged perspective view of the muzzle in FIG. 1;

FIG. 3 is a side plan view in partial section of the muzzle of a nail gun in FIG. 2;

FIG. 4 is a perspective view of a nail gun with a muzzle in accordance with the present invention;

FIG. 5 is an operational plan view of the muzzle of a nail gun in FIG. 2; and

FIG. 6 is an operational side plan view in partial section of the muzzle of a nail gun in FIG. 3.

### DETAILED DESCRIPTION OF THE PREFERRED EMBODIMENT

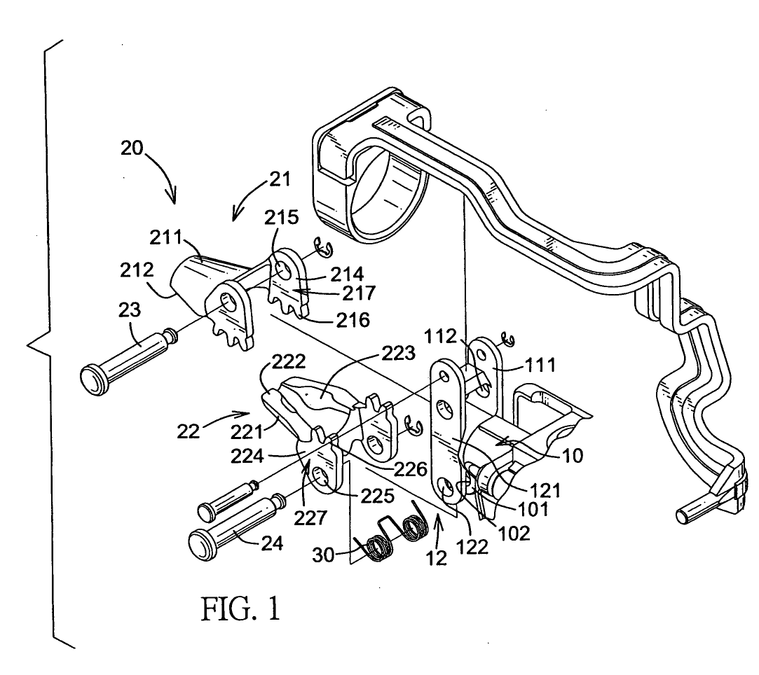

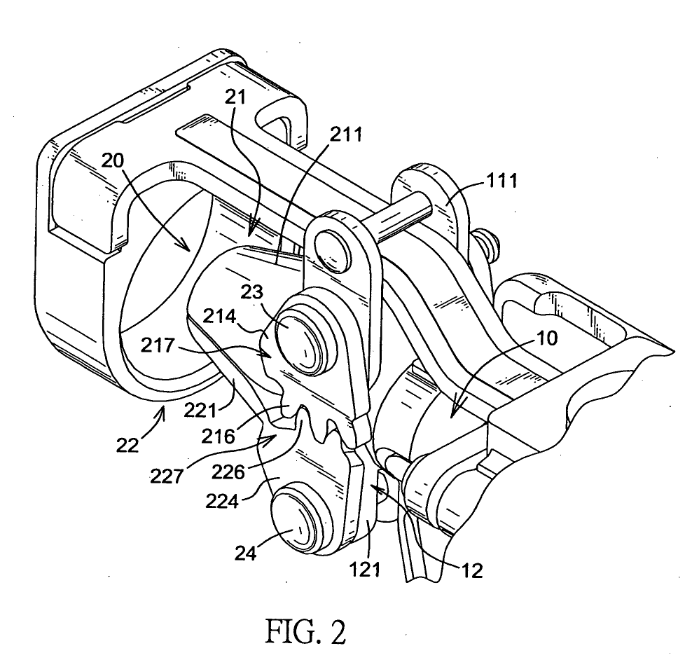

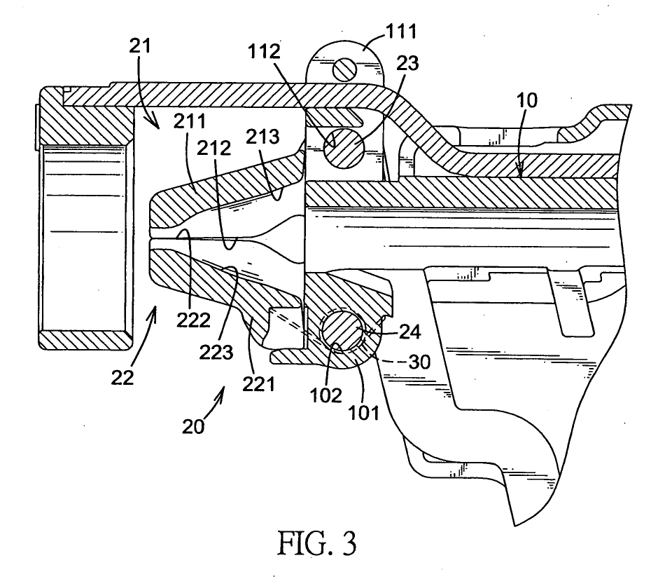

With reference to FIGS. 1 to 4, a nail gun in accordance with the present invention comprises a gun body (10), a muzzle (20) and a spring (30).

The gun body (10) has a distal end, a bottom, two sides, an extended tongue (101), a hole (102) and a pivot seat. The extended tongue (101) is formed on the bottom of the gun body (10). The hole (102) is defined in the extended tongue (101). The pivot seat is mounted on the distal end of gun body (10) and has two side plates (111, 121), two first pivot holes (112) and two second pivot holes (122). The two side plates (111, 121) both have a top and a bottom. The two first pivot holes (112) are respectively defined near the tops of the side plates (111, 121) of the pivot seat. The two second pivot holes (122) are respectively defined near the bottoms of the side plates (111, 121) of the pivot seat. The second pivot holes (122) correspond to and aligns with the hole (102) in the extended tongue (101).

The muzzle (20) is pivotally mounted on the pivot seat of the nail gun body (10) and has a taper shape. The muzzle (20) has a top case (21), a bottom case (22), a first pin (23) and a second pin (24). The top case (21) is pivotally mounted on the top of the pivot seat and has a proximal end, a distal end (211), two sides, a bottom surface (212), a recess (213) and an engaging part (217). The recess (213) is defined in the bottom surface (212) from the distal end (211) to the proximal end. The engaging part (217) is formed on the proximal end of the top case (21) and has two ears (214), two pivot holes (215) and multiple teeth (216). The ears (214) are respectively mounted on the two sides and each has a bottom edge. The pivot holes (215) are respectively defined through the ears (214) and correspond to the first pivot holes (112) in the pivot seat. The multiple teeth (216) are formed on the bottom edges of the ears (214). The bottom case (22) is pivotally mounted on the bottom of the pivot seat and is connected with the top case (21). The bottom case (22) has a proximal end, a distal end (221), two sides, a top surface (222), a recess (223) and an engaging part (227). The top surface (222) of the bottom case (22) faces to the bottom surface (212) of the top case (21). The recess (223) is defined in the top surface (222) and faces to the recess (213) in the top case (21) to form a channel. The engaging part (227) is formed on the proximal end of the bottom case (22) and engages with the engaging part (217) on the top case (21). The engaging part (227) has two ears (224), two pivot holes (225) and multiple teeth (226). The ears (224) are respectively mounted on the two sides and each has a top edge. The pivot holes (225) are respectively defined through the ears (224) and correspond to the second pivot holes (122) defined in the pivot seat. The multiple teeth (226) are formed on the bottom edges of the ears (214) and engage with the multiple teeth (216) on the top case (21). The first pin (23) is mounted through the pivot holes (215, 112) respectively defined in the top case (21) and the pivot seat. The second pin (24) is mounted through the pivot holes (225, 122) respectively defined in the bottom case (21) and the pivot seat.

The spring (30) is mounted around the second pin (24) and is mounted between the bottom case (12) and pivot seat and has two ends. One end of the spring (30) is mounted on the proximal end of the bottom case (22) and the other end of the spring (30) is mounted on the extended tongue (101) of the nail gun body (10).

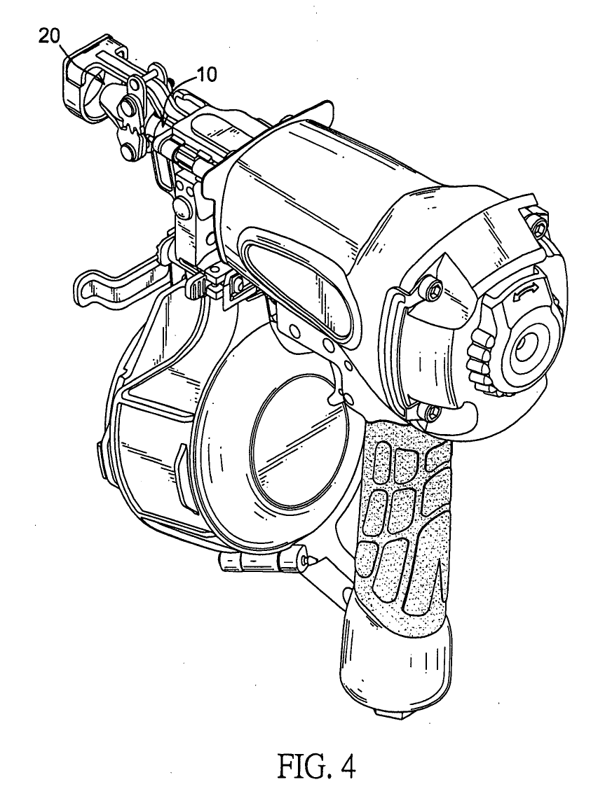

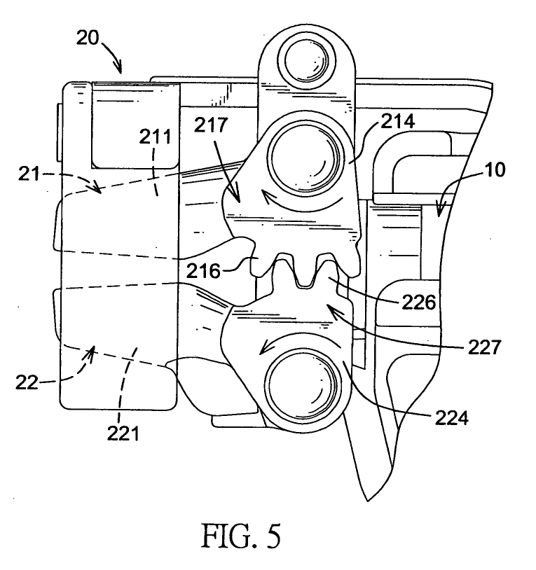

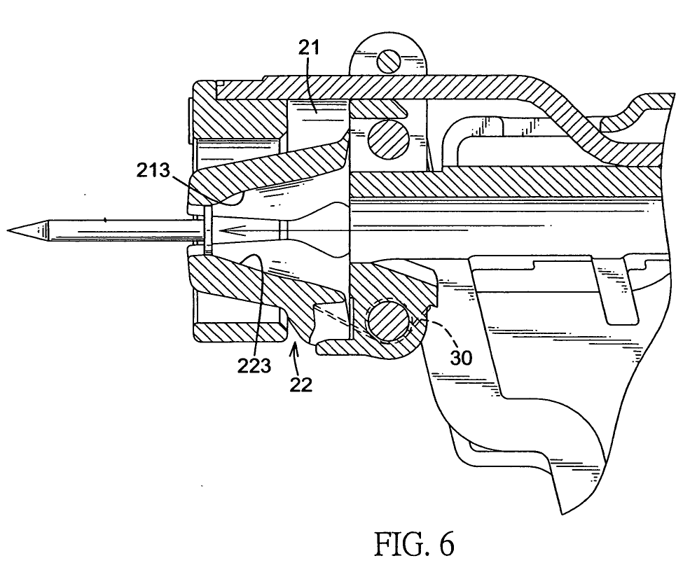

With reference to FIGS. 4 to 6, when the nail gun in accordance with the present invention is in use, a nail is mounted inside the channel formed by the recesses (213, 223) and is driven to shoot out from the channel by compressed air. When the nail passing, the top case (21) and the bottom case (22) are rotated around the pins (23, 24) to make the muzzle (20) open. With the engagement of the teeth (216, 226) on the cases (21,22), the rotating angle of the cases (21, 22) will be the same and the nail will be applied with a balance force when passing the channel. Therefore, the nail will pass along a straight path.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A nail gun comprising:
a gun body having
a distal end, and
a pivot seat,
a muzzle pivotally mounted on the gun body and having
a top case pivotally mounted on the gun body and having
a proximal end pivotally mounted on the distal end of the gun body,
a distal end,
two sides,
a bottom surface,
a recess defined in the bottom surface from the distal end to the proximal end, and
an engaging part formed on the proximal end of the top case,
a bottom case pivotally mounted on the bottom of the pivot seat of the gun body, connected with the top case and having
a proximal end,
a distal end,
two sides,
a top surface facing to the bottom surface of the top case,
a recess defined in the top surface and corresponding to the recess in the top case to form a channel, and
an engaging part formed on the proximal end of the bottom case and engaging the engaging part of the top case for opening simultaneously with the top case and opening at an equal angle,
a first pin mounted through the top case and the pivot seat, and
a second pin mounted through the bottom case and the pivot seat, and
a spring mounted around the second pin and between the bottom case and the gun body.

2. The nail gun as claimed in claim 1, wherein the gun body has
a distal end,
a bottom,
two sides,
an extended tongue formed on the bottom of the gun body,
a hole defined in the extended tongue, and
a pivot seat mounted on the distal end of gun body and having
two side plates, both side plates having a top and a bottom,
two first pivot holes defined respectively near the tops of the side plates of the pivot seat, and
two second pivot holes defined respectively near the bottoms of the side plates of the pivot seat and corresponding to the hole defined in the extended tongue,
the engaging part of the top case of the muzzle further comprises
two ears mounted respectively on the two sides of the top case and each having a bottom edge,
two pivot holes defined respectively through the ears and corresponding to the first pivot holes defined in the pivot seat, and
multiple teeth formed on the bottom edges of the ears, and
the engaging part of the bottom case of the muzzle further comprises
two ears mounted respectively on the two sides and having a top edge,
two pivot holes defined respectively through the ears and corresponding to the second pivot holes defined in the pivot seat, and
multiple teeth formed on the top edges of the ears and engaging with the multiple teeth on the top case.

3. The nail gun as claimed in claim 2, wherein the spring has two ends, and
one end of the spring is mounted on the proximal end of the bottom case, and
the other end of the spring is mounted on the extended tongue of the gun body.
